(19) United States
(12) Patent Application Publication
(10) Pub. No.: US 2026/0358859 A1
(43) Pub. Date: Nov. 12, 2026

(54) Display Positioning System for a Portable Computing Device

(71) Applicant: Volodymyr Nikolaichuk, Kyiv (UA)

(72) Inventor: Volodymyr Nikolaichuk, Kyiv (UA)

(21) Appl. No.: 19/672,611

(22) Filed: May 9, 2026

Related U.S. Application Data
(60) Provisional application No. 63/803,836, filed on May 11, 2025.

(51) Int. Cl. G06F 1/16

(52) U.S. Cl. CPC G06F 1/1637

(57) ABSTRACT

A display positioning system for a portable computing device is disclosed. The system comprises a base housing and a display assembly coupled by a support mechanism including a guide structure and a plurality of articulated support members. The support mechanism is configured to transition between a stowed configuration and a deployed configuration to reposition the display assembly relative to the base housing. Translational displacement along the guide structure produces coordinated angular movement of the articulated support members through a kinematically constrained relationship, resulting in combined vertical elevation and forward displacement of the display assembly. The support mechanism is substantially integrated within the base housing in the stowed configuration. The system further comprises a cable management system including a dynamic length-compensation mechanism configured to regulate tension of one or more data conduits during movement. The system operates without reliance on telescopic extension elements while maintaining a compact device configuration.

### CROSS-REFERENCE TO RELATED APPLICATIONS

This application claims the benefit of U.S. Provisional Application No. 63/803,836, filed on May 11, 2025, the contents of which are hereby incorporated by reference in their entirety.

### STATEMENT REGARDING FEDERALLY SPONSORED RESEARCH OR DEVELOPMENT

Not applicable.

### TECHNICAL FIELD

The invention relates to the field of portable computing devices, and more particularly to mechanical and structural systems for supporting and repositioning a display assembly in laptops and similar form-factor devices.

More specifically, the invention relates to articulated support mechanisms integrated within the device structure and configured to provide multi-axis controlled displacement and orientation of a display assembly relative to a base housing, facilitating a coordinated vertical and forward movement path while maintaining a compact form factor in a stowed configuration within a spatial envelope of the base housing.

### BACKGROUND OF THE INVENTION

Modern portable computing devices, particularly laptop computers, typically employ fixed hinge mechanisms that position a display assembly directly behind a keyboard at a relatively low height. This configuration may require users to tilt their head downward, which can contribute to neck strain, suboptimal posture, and discomfort during extended use.

Various approaches have been proposed to address these limitations. These approaches generally fall into several categories.

A first category includes external elevating stands and support accessories, which can improve viewing height but require additional components separate from the device and do not provide an integrated solution.

A second category includes integrated telescopic or lifting mechanisms, which rely on extendable structures or linear elevation systems. Such mechanisms may introduce increased structural complexity and may affect stability, and limited control over display orientation.

A third category includes sliding and rail-based mechanisms, wherein a display assembly is translated relative to the base housing. While such systems enable displacement, they may lack coordinated multi-axis motion and can require guiding tracks or openings in the device chassis, which may allow ingress of debris and affect the structural continuity of the enclosure. In some implementations, such systems may also rely on friction-based positioning elements that can degrade over time.

A fourth category includes hinge-based and multi-link mechanisms, which provide rotational movement of the display. These systems are often limited in their degrees of freedom and may not provide simultaneous vertical and forward repositioning of the display assembly.

A fifth category includes hybrid mechanisms combining sliding, lifting, and rotational elements. Although such systems can provide increased flexibility, they may result in increased mechanical complexity and reduced efficiency of motion.

A sixth category involves cable management within moving display assemblies. Existing solutions often rely on passive slack accumulation, which may result in uncontrolled cable movement, potential mechanical interference with internal components, and increased wear during repeated transformations.

In addition, alternative approaches based on flexible, foldable, or rollable displays have been proposed. While such technologies enable compact form factors, they rely on flexible materials subject to bending constraints, where repeated deformation may lead to degradation of conductive elements and signal reliability, particularly in the absence of active tension management.

Across these categories, several common limitations are observed. Such limitations may include, for example, increased device thickness or external bulk, insufficient structural rigidity of the display support, lack of coordinated multi-axis motion, exposure of internal components, including data conduits, to repeated bending, variable tension, and wear, reliance on telescopic or flexible elements, which may reduce long-term reliability, and difficulty in maintaining a compact and integrated form factor in a stowed configuration.

Accordingly, there remains a need for an integrated display positioning system that provides controlled multi-axis movement, improved structural stability, and enhanced durability, while maintaining a compact form factor within the device.

### BRIEF SUMMARY OF THE INVENTION

The present invention provides a portable computing device comprising a display positioning system configured to enable controlled repositioning of a display assembly relative to a base housing.

The system includes a support mechanism integrated within the device structure and configured to transition between a stowed configuration and a deployed configuration. In the deployed configuration, the support mechanism elevates and repositions the display assembly relative to the base housing through a defined and coordinated sequence of motions.

The support mechanism comprises one or more articulated support members operatively coupled to a guide structure disposed within the base housing, and optionally to a linear displacement member, such as a carriage. The system is configured to facilitate a combined vertical and forward movement path of the display assembly without reliance on telescopic extension elements, thereby maintaining structural rigidity and a compact mechanical profile.

In certain embodiments, displacement of an internal guide element facilitates corresponding angular displacement of the articulated support members, wherein the transformation is facilitated through mechanical coupling between moving components of the support mechanism, thereby enabling a synchronized transition of the display assembly from a position within a spatial envelope of the base housing to an elevated ergonomic position.

The system further includes an internal routing path for a data conduit extending between the base housing and the display assembly. The routing path is associated with an active length-compensation mechanism configured to regulate tension and reduce slack accumulation during positional transitions, thereby mitigating potential mechanical interference with internal components and reducing stress-induced wear on the data conduit.

In certain implementations, the articulated support members may comprise a multi-segment kinematic arrangement including a plurality of pivot joints arranged to provide non-linear motion of the display assembly.

The disclosed system provides improved structural stability, controlled motion behavior, and enhanced durability, while preserving a compact and integrated device configuration suitable for portable computing applications.

### BRIEF DESCRIPTION OF THE DRAWINGS

FIG. 1 is a perspective view of the portable computing device in a stowed configuration.

FIG. 2 is a perspective view of the portable computing device with guide rails extended from the base housing.

FIG. 3 is a perspective view of the portable computing device in a partially elevated configuration.

FIG. 4 is a perspective view of the portable computing device in a deployed configuration.

FIG. 5 is a sequence of views (a)-(d) illustrating deployment of the support mechanism.

FIG. 6 is a sequence of views (a)-(e) illustrating internal movement of the support mechanism during deployment.

FIG. 7 is a set of views illustrating the articulated support mechanism with reference elements.

FIG. 8 is a set of views illustrating different configurations of the support mechanism during deployment.

FIG. 9 is a perspective view of the support mechanism with internal routing structures.

### DETAILED DESCRIPTION OF EMBODIMENTS

The present invention relates to a display positioning system for a portable computing device, configured to enable controlled repositioning of a display assembly relative to a base housing. Reference will now be made in detail to embodiments of the invention, examples of which are illustrated in the accompanying drawings.

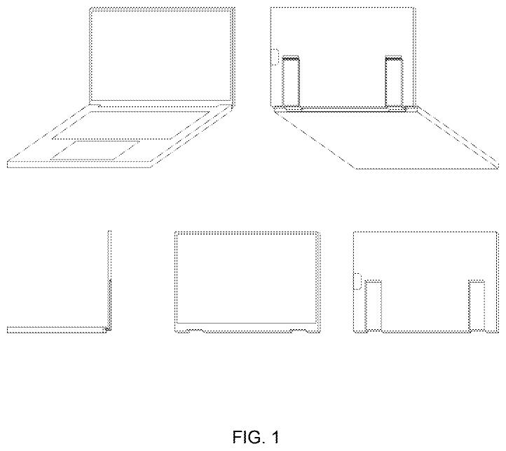

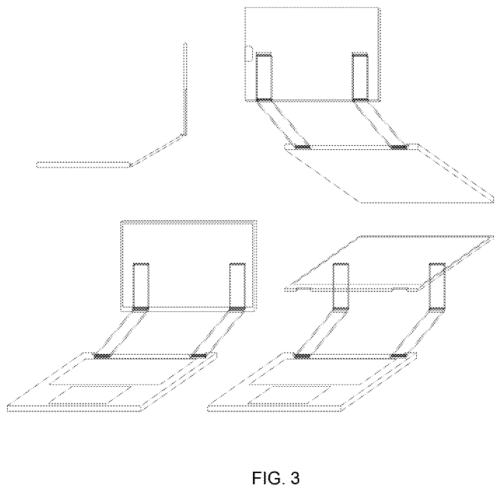

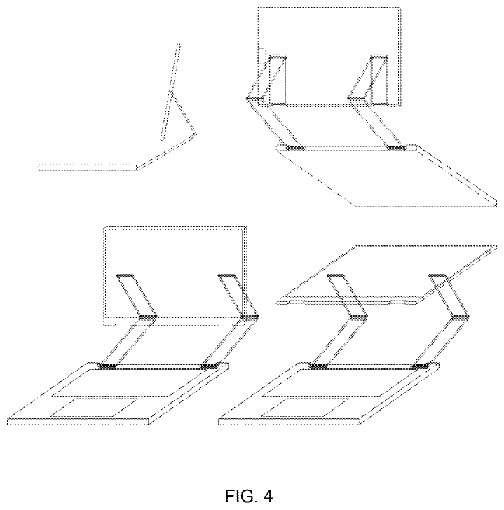

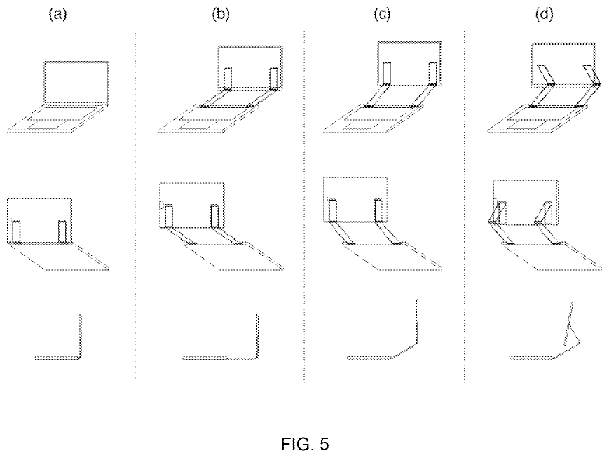

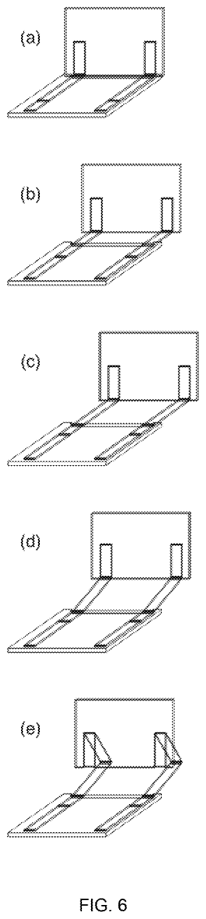

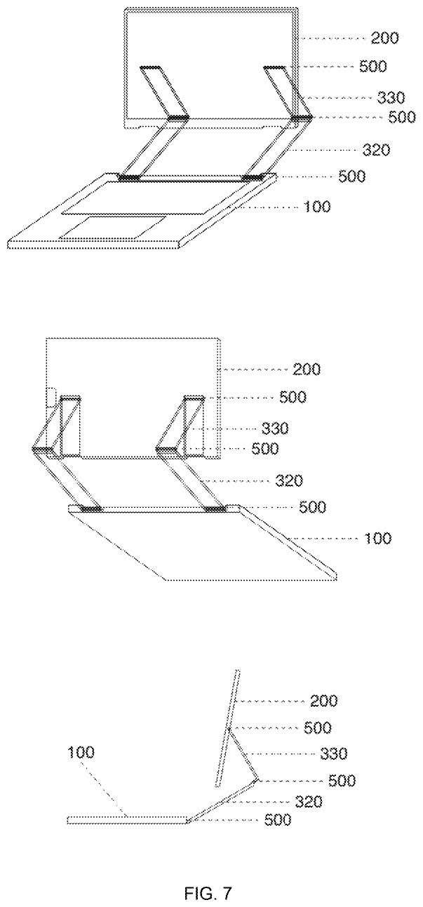

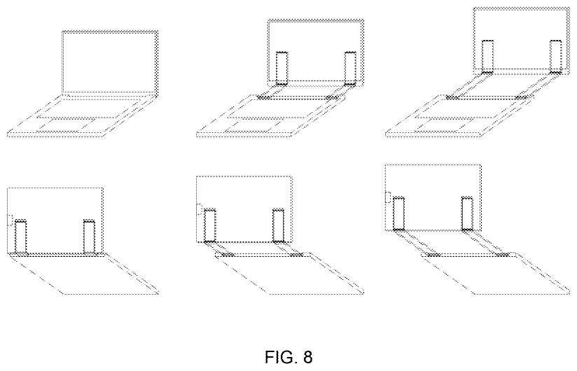

Referring to the accompanying drawings, the device is illustrated in multiple configurations and operational states. FIG. 1 through FIG. 4 illustrate external configurations of the device during deployment, FIG. 5 and FIG. 6 illustrate sequential movement of the support mechanism, and FIG. 7 through FIG. 9 illustrate structural and functional aspects of the support mechanism and associated components.

The system comprises an internal support mechanism including a guide structure and one or more articulated support members configured to transition between a stowed configuration and a deployed configuration. The support mechanism is configured to be substantially integrated within the base housing, thereby minimizing its impact on the overall external profile of the device.

In the deployed configuration, the system is configured to elevate and reposition the display assembly relative to the base housing through a coordinated sequence of translational and angular movements. This coordinated movement is configured to produce a controlled trajectory, resulting in a combined vertical elevation and forward displacement of the display assembly while maintaining structural stability and compact integration within the spatial envelope of the device.

### Base Housing

The portable computing device comprises a base housing configured to accommodate internal components of the device and to support a display positioning system.

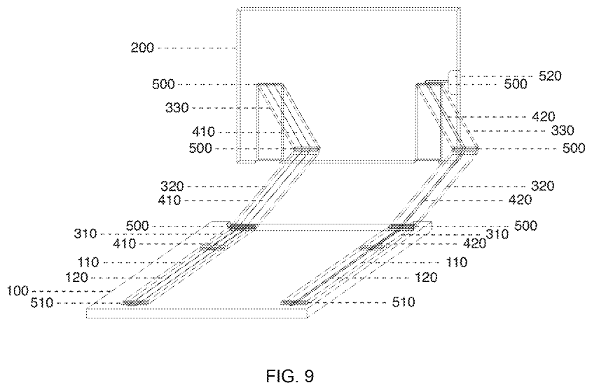

Referring to FIG. 7 and FIG. 9, the base housing (100) is configured to accommodate the support mechanism and associated internal components.

In certain embodiments, the base housing may include one or more structural elements (120).

The base housing includes an internal volume dimensioned to receive at least a portion of a support mechanism in a stowed configuration, such that the support mechanism is substantially contained within the spatial envelope of the base housing without increasing an external profile of the device.

In certain embodiments, the internal volume may be positioned below a primary input surface of the base housing, thereby utilizing available interior space without requiring external protrusions and preserving the structural continuity of exterior surfaces. The stowed configuration may also be referred to as a stowed position.

The base housing further defines one or more internal guide regions configured to support movement of elements of the support mechanism during transition between the stowed configuration and a deployed configuration. The guide regions are integrated into the device structure to facilitate stable alignment of the support mechanism and to reduce exposure to external contaminants.

In certain embodiments, the base housing may include one or more recesses, channels, or cavities configured to receive articulated support members and associated components of the display positioning system.

The base housing is further configured to provide structural support and positional alignment for the support mechanism during both operation and positional transformation.

### Guide Structure

The display positioning system includes a guide structure configured to facilitate controlled movement of the support mechanism relative to the base housing.

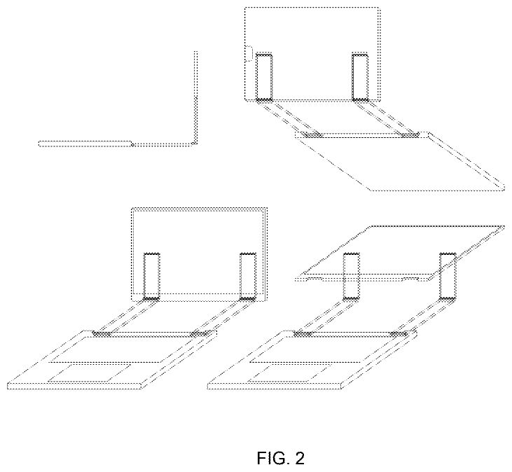

Referring to FIG. 2 and FIG. 6, the guide structure enables controlled translational movement of elements of the support mechanism along a defined guide path.

In certain embodiments, the guide structure may include one or more guide rail elements (110).

The guide structure may comprise one or more guide members, including channels, tracks, or equivalent guiding structures, configured to enable translational displacement of at least a portion of the support mechanism along a defined guide path. In certain embodiments, the guide structure is disposed within the base housing such that it is substantially concealed within the device structure, thereby preserving structural continuity and aesthetic integrity of exterior surfaces.

The guide path is disposed internally within the base housing and may be referred to as an internal guide path.

In certain embodiments, the internal volume of the guide structure or associated components may be configured to accommodate one or more transmission elements associated with actuation or control of the support mechanism.

The guide structure may include one or more low-friction interfaces, such as glide elements, bearing systems, or treated surfaces, configured to facilitate smooth and stable translation of a linear displacement member, such as a carriage or sliding element.

In certain embodiments, the system may include one or more stop elements (510).

Additionally, it may include one or more travel limits or end-stop features configured to define boundaries of translational movement between a stowed configuration and a deployed configuration.

The guide structure is dimensioned to provide sufficient travel distance for transition between configurations and may include constraint features configured to reduce lateral movement, minimize vibration, and maintain alignment of the support mechanism during operation.

In certain embodiments, the guide structure may be integrated with or coupled to structural members of the base housing and configured to improve structural rigidity during extension of the support mechanism.

In further embodiments, the guide structure is configured to constrain movement of the support mechanism along a defined trajectory and to facilitate coordinated interaction between translational movement and angular displacement of the support mechanism, thereby enabling controlled repositioning of the display assembly without reliance on telescopic extension elements.

### Articulated Support Members

The display positioning system further comprises one or more articulated support members configured to support and reposition the display assembly relative to the base housing.

Referring to FIG. 7, the articulated support members (320, 330) are arranged as a multi-segment kinematic structure configured to support and reposition the display assembly (200).

Each articulated support member is operatively coupled to the guide structure and is configured to move relative to the base housing between a stowed configuration and a deployed configuration. In the stowed configuration, at least a portion of the articulated support members is received within the internal volume of the base housing. In certain embodiments, segments of the articulated support members may be configured with a nesting or interleaving geometry to minimize their combined profile within the spatial envelope of the base housing.

In certain embodiments, the display positioning system comprises a plurality of articulated support members arranged to provide balanced support of the display assembly.

In certain embodiments, the support mechanism may comprise a single articulated support member or multiple support members depending on design requirements.

Each articulated support member may comprise one or more interconnected segments linked by pivot joints and forming a multi-segment kinematic arrangement. In certain embodiments, each articulated support member may include at least a first pivot interface coupled to the guide structure and a second pivot interface coupled to the display assembly.

In certain embodiments, the articulated support members may include one or more coupling elements (310).

The articulated support members are configured to facilitate transformation of translational displacement along the guide structure into coordinated angular movement, thereby enabling a combined vertical elevation and forward displacement of the display assembly without reliance on telescopic extension elements.

The articulated support members may be positioned inward from lateral edges of the base housing to enable forward displacement of the display assembly toward a front side of the device. In certain embodiments, the articulated support members may be symmetrically positioned relative to a central longitudinal axis of the base housing, thereby providing balanced support of the display assembly.

In the deployed configuration, the articulated support members are configured to provide structural rigidity and resistance to deflection, maintaining a stable viewing position of the display assembly. In certain embodiments, the articulated support members may include features such as mechanical interlocking or biased tensioning elements to enhance stability during operation.

In certain embodiments, the articulated support members form a generally Z-shaped configuration in the deployed configuration, wherein segments of the articulated support members are angularly offset relative to one another to define a Z-shaped profile when viewed from a lateral perspective.

### Articulation System

The display positioning system further comprises an articulation system configured to enable relative movement between components of the support mechanism and the display assembly.

Referring to FIG. 7, the articulation system includes a plurality of pivot joints (500) forming a kinematic linkage between segments of the articulated support members and coupling the support members to the guide structure and the display assembly.

In certain embodiments, the articulation system forms a closed kinematic chain, wherein movement of one segment produces corresponding movement of other segments through geometric constraints.

In certain embodiments, such geometric constraints define a predetermined relationship between translational movement along the guide structure and angular displacement at the pivot joints.

The pivot joints are configured to permit controlled angular displacement between connected components during transition between a stowed configuration and a deployed configuration, and may define a plurality of axes of rotation configured to promote synchronized movement and reduce mechanical binding during operation.

In certain embodiments, the articulation system may be implemented using alternative jointing or linkage mechanisms, including compliant or multi-axis arrangements, capable of providing substantially equivalent coordinated motion and angular displacement.

The pivot joints may define a plurality of axes of rotation arranged to promote synchronized movement and reduce mechanical binding during operation.

In further embodiments, the articulation system comprises a plurality of pivot joints arranged to define a multi-joint kinematic chain. The pivot joints may incorporate friction-based torque elements or biasing members configured to maintain the display assembly in a plurality of stable positions during operation.

The articulation system is configured to facilitate coordinated interaction between angular displacement at the pivot joints and translational movement along the guide structure. In certain embodiments, the articulation system may include mechanical linkages configured such that angular displacement at one pivot joint facilitates corresponding displacement at one or more additional pivot joints, thereby enabling a controlled transformation of the display assembly along a combined vertical and forward trajectory.

In certain embodiments, the pivot joints may be arranged to form a folded or offset configuration in the stowed state and an extended configuration in the deployed state, thereby enabling compact storage of the support mechanism within the spatial envelope of the base housing.

The articulation system may further include damping features configured to regulate motion, reduce abrupt transitions, and enhance smoothness of operation.

In certain embodiments, the articulation system is configured to maintain a substantially stable viewing orientation of the display assembly during at least a portion of the transition between configurations.

### Protective Structures

The display positioning system may further comprise one or more protective structures configured to shield components of the support mechanism and associated elements from external contaminants and mechanical interaction during operation.

In certain embodiments, the protective cover comprises a segmented articulated structure, wherein individual segments are configured to move relative to one another to accommodate movement of the support mechanism during deployment.

In certain embodiments, the protective cover is configured to maintain coverage continuity during movement. As used herein, “coverage continuity” refers to the ability of the protective structure to provide a substantially continuous barrier over internal components throughout at least a portion of the range of motion, and in certain embodiments throughout the entire range of motion, while accommodating relative movement between segments of the structure.

In certain embodiments, the protective structures are positioned adjacent to or over portions of the articulation system and/or the guide structure, including regions associated with pivot joints and internal routing paths. The protective structures may be configured to at least partially enclose potential pinch points within the support mechanism, thereby reducing the risk of mechanical interference with external objects or user digits during transformation.

The protective structures may comprise one or more movable or deformable segments configured to adapt to positional changes of the support mechanism during transition between a stowed configuration and a deployed configuration.

In certain embodiments, the protective structures may be configured to expand, contract, or move relative to one another, thereby maintaining a substantially continuous barrier over protected components throughout at least a portion of the range of motion.

The protective structures may be configured to prevent ingress of particulate matter, debris, or other contaminants into internal regions of the support mechanism, while permitting unobstructed movement of the articulated support members and associated components.

In certain embodiments, the protective structures may be integrated with or coupled to portions of the support mechanism and may be configured to move in coordination with the articulation system.

In certain embodiments, the protective structures may be configured to be substantially flush with or recessed relative to exterior surfaces of the base housing, thereby preserving a streamlined and integrated device profile in the stowed configuration.

The protective structures may further be configured to reduce exposure of internal components to mechanical interference during operation and to enhance durability of the display positioning system over repeated transformation cycles.

### Locking and Stability Mechanism

The display positioning system may further comprise one or more locking or stabilization mechanisms configured to control movement of the support mechanism and to maintain the display assembly in one or more selected positions.

In certain embodiments, the locking or stabilization mechanisms are configured to selectively resist movement of the support mechanism along the guide structure and/or within the articulation system, thereby maintaining the display assembly in a desired position during use.

The locking or stabilization mechanisms may comprise one or more passive or active elements, including friction interfaces, detent features, magnetic elements, spring-biased components, or electromechanical actuators configured to provide positional retention.

In certain embodiments, the locking or stabilization mechanisms may be associated with an actuation system configured to release or disengage the mechanism.

Such actuation may be implemented using mechanical transmission elements, including cables, wires, flexible tension members, or linkage structures operatively coupled to a user input element.

In certain embodiments, the actuation system may include a user-actuated release element, such as a button or switch, corresponding to the release actuator (520) shown in FIG. 9.

In other embodiments, the actuation system may comprise one or more electromechanical components, including solenoids, actuators, or motor-driven elements configured to selectively disengage the locking mechanism in response to an input signal. Said input signal may be generated by a user-operated sensor or provided by a control system of the electronic device.

Both mechanical and electromechanical implementations are configured to achieve substantially equivalent functional outcomes, differing primarily in the mode of actuation while preserving the overall kinematic behavior of the system.

In certain embodiments, the locking or stabilization mechanisms may include biasing elements configured to provide a self-securing or self-assisting force as the support mechanism approaches the stowed or deployed configurations.

In certain embodiments, the locking or stabilization mechanisms may be configured to provide a plurality of stable positions, including intermediate positions between the stowed configuration and the deployed configuration.

The locking or stabilization mechanisms may be integrated with the guide structure, the articulation system, or both, and may operate in coordination with the movement of the support mechanism.

In certain embodiments, the locking or stabilization mechanisms may be configured to provide controlled resistance to movement, thereby reducing unintended displacement due to external forces, vibration, or gravity.

In certain embodiments, the locking or stabilization mechanisms may be configured to enhance torsional rigidity and reduce display oscillation during user interaction.

The locking or stabilization mechanisms may further be configured to provide sufficient resistance to counteract forces acting on the display assembly while permitting manual repositioning by a user without auxiliary tools.

The locking or stabilization mechanisms may further be configured to provide tactile or haptic feedback during positional adjustment, thereby enhancing user control and interaction.

### Cable Management System

The display positioning system further comprises a cable management system configured to route and protect one or more data conduits extending between the base housing and the display assembly.

The cable management system defines an internal routing path configured to guide the data conduit through or alongside the guide structure and articulated support members. In certain embodiments, the routing path may be at least partially enclosed within portions of the support mechanism, including the articulated support members or the guide structure, thereby providing mechanical shielding from external objects and internal moving components.

In certain embodiments, the routing path may correspond to the data cable routing channel (410) and/or the mechanical transmission channel (420) as illustrated in FIG. 9.

In certain embodiments, the cable management system is configured to accommodate changes in relative distance between the base housing and the display assembly during transition between a stowed configuration and a deployed configuration.

In certain embodiments, the cable management system comprises a dynamic length-compensation mechanism configured to regulate tension within the data conduit during movement of the support mechanism.

In certain embodiments, the tensioning mechanism may include a spring-loaded element and/or a sliding loop guide configured to maintain the data conduit in a taut state and to accommodate changes in conduit length during movement.

The dynamic length-compensation mechanism may be configured to reduce slack accumulation and maintain controlled tension within the data conduit, thereby mitigating potential mechanical interference with moving components.

In certain embodiments, the cable management system may be configured to reduce the likelihood of the data conduit entering entrapment zones or pinch points within the support mechanism.

In certain embodiments, the cable management system may include one or more guiding features configured to maintain the data conduit within a controlled bend radius sufficient to reduce stress concentrations, fatigue, and signal degradation during repeated transformation cycles.

The cable management system may further be configured to reduce stress concentrations, limit excessive bending, and enhance durability of the data conduit over repeated transformation cycles.

In certain embodiments, the cable management system may be integrated with the support mechanism and configured to operate in kinematic coordination with movement of the guide structure and articulation system.

The cable management system may be configured to maintain a substantially continuous and protected routing path throughout the range of motion of the display positioning system.

### Materials and Structural Implementation

The display positioning system and associated components may be constructed from one or more materials selected to provide structural strength, dimensional stability, and resistance to wear during repeated operation.

In certain embodiments, the articulated support members, guide structure, and associated load-bearing elements may comprise metallic materials, composite materials, or combinations thereof, configured to provide sufficient rigidity and resistance to deformation under operational loads.

In certain embodiments, high-modulus materials may be utilized to enhance structural stiffness and reduce deflection of the display assembly in the deployed configuration.

The components of the support mechanism may be manufactured using machining, forming, casting, additive manufacturing, or other suitable fabrication techniques, depending on design requirements and intended production scale.

In certain embodiments, surface treatments or coatings may be applied to selected components to reduce friction, improve wear resistance, and enhance durability over repeated transformation cycles.

The display positioning system may include structural reinforcements, internal ribs, or support interfaces configured to distribute loads and maintain alignment of the support mechanism during operation.

In certain embodiments, the components of the support mechanism may be configured to provide a balance between structural rigidity and weight, thereby maintaining portability of the device while ensuring reliable performance.

In certain embodiments, the selection of materials and structural configuration is coordinated with the kinematic behavior of the support mechanism to maintain dimensional stability, reduce deformation under load, and ensure consistent alignment of the display assembly during movement and in deployed configurations.

### Operational Sequence

The display positioning system is configured to transition between a stowed configuration and a deployed configuration through a coordinated sequence of movements involving the guide structure, articulated support members, and articulation system.

Referring to FIG. 5 and FIG. 6, the transition between configurations involves coordinated translational and angular movement of the support mechanism.

In the stowed configuration, the support mechanism is at least partially contained within the base housing, with the display assembly positioned within the spatial envelope of the device.

During transition to the deployed configuration, at least a portion of the support mechanism is displaced relative to the base housing along a defined guide path. This translational displacement facilitates corresponding angular displacement within the articulated support members.

The system is configured such that translational movement along the guide structure and angular movement within the articulation system occur in a coordinated manner, producing a controlled repositioning of the display assembly.

In certain embodiments, the coordinated movement results in a combined vertical elevation and forward displacement of the display assembly relative to the base housing.

In certain embodiments, the display assembly may maintain a substantially stable orientation during at least a portion of the transition between configurations.

The cable management system is configured to operate in coordination with the movement of the support mechanism, accommodating changes in routing length and maintaining controlled positioning of the data conduit throughout the transition.

The protective structures and locking or stabilization mechanisms may also operate in coordination with the movement of the support mechanism, contributing to controlled motion, positional stability, and protection of internal components during transformation.

In certain embodiments, the transition between configurations may be initiated manually by a user or assisted by one or more active components.

### Functional Advantages

The display positioning system described herein provides a number of functional and structural advantages arising from the coordinated interaction of its components.

In certain embodiments, the system enables controlled repositioning of a display assembly relative to a base housing while maintaining a compact configuration in the stowed state, thereby preserving the overall external profile of the device.

The coordinated interaction between the guide structure and the articulation system facilitates a combined vertical and forward displacement of the display assembly, improving ergonomic positioning without requiring additional external components.

In certain embodiments, the articulated support members and associated structures provide enhanced structural rigidity and resistance to deflection in the deployed configuration, thereby maintaining a stable viewing position during use.

The integration of a cable management system with dynamic length-compensation may reduce stress on data conduits, limit excessive bending, and mitigate mechanical interference during repeated transformation cycles.

In certain embodiments, the protective structures reduce exposure of internal components to contaminants and mechanical interaction, thereby enhancing durability and reliability of the system.

The locking or stabilization mechanisms may provide controlled positional retention, reducing unintended movement due to external forces and enabling stable positioning of the display assembly in multiple configurations.

In certain embodiments, the system is configured to reduce oscillation of the display assembly during user interaction and to maintain controlled motion behavior throughout the transition between configurations.

The described configuration enables integration of the display positioning system within the spatial envelope of the base housing, thereby maintaining a streamlined device form while supporting a range of adjustable display positions.

In certain embodiments, the system provides improved durability, controlled motion characteristics, and enhanced user interaction without requiring reliance on telescopic extension elements or external support structures.

In certain embodiments, the described configuration enables improved coordination between translational and angular movement, resulting in a predictable and repeatable motion path of the display assembly. This coordinated behavior may contribute to enhanced user ergonomics, improved structural efficiency, and reduced mechanical stress on internal components during operation.

### Technical Flexibility and Variations

In certain embodiments, the configurations illustrated in FIG. 5 through FIG. 9 may be modified without departing from the scope of the invention.

The display positioning system described herein is inherently adaptable and may be implemented in a variety of configurations without departing from the core inventive concept as defined by the claims. The following variations and implementations are intended to be included within the scope of the invention.

In certain embodiments, the guide structure, articulated support members, and associated components may be varied in size, proportion, cross-sectional geometry, and internal configuration to accommodate different device form factors and design constraints. Such variations may include differences in relative dimensions, spatial arrangement, and structural integration within the base housing while preserving the functional relationship between translational displacement and coordinated angular movement.

In certain embodiments, the articulation system may comprise varying numbers, arrangements, and configurations of pivot joints and interconnected segments. Different kinematic arrangements may be employed to achieve controlled non-linear displacement of the display assembly, including configurations optimized for stability, compactness, or specific motion characteristics.

In certain embodiments, the guide structure may be positioned in various locations within the base housing, including central, lateral, or distributed configurations. One or more guide paths may be utilized to support coordinated movement of the support mechanism without limitation to a specific number or orientation of guide elements.

In certain embodiments, the components of the display positioning system may be fabricated from a wide range of materials and using various manufacturing processes. Material selection and fabrication techniques may be adapted to achieve desired characteristics including strength, stiffness, weight reduction, durability, and manufacturability.

In certain embodiments, the system may be configured to provide varying ranges of motion, positional constraints, and resistance characteristics. Such variations may be implemented through adjustment of structural geometry, articulation design, or interaction between components. Movement may be initiated manually by a user, assisted by internal biasing elements, or driven by one or more active components, including electromechanical actuators, without limiting the fundamental coordinated motion behavior of the system.

In certain embodiments, the cable management system may be implemented using different routing paths, guiding structures, and length-compensation mechanisms. The conduit path may be managed using mechanisms configured to regulate tension and control bending. The system is intended to accommodate various conduit types, including but not limited to electrical wiring, data ribbons, fiber optics, or fluidic conduits for thermal management.

In certain embodiments, protective structures and stabilization mechanisms may be implemented in a variety of forms and configurations, including different arrangements of shielding elements, retention systems, and motion control features. Such variations may be configured to enhance durability, stability, and controlled operation of the system.

In certain embodiments, the display positioning system may be applied to a range of device types and form factors, including portable computing devices and other display-based systems. The structural and functional principles described herein may be scaled or adapted to accommodate different sizes, use cases, and operational environments.

In certain embodiments, the external appearance, integration approach, and user interaction characteristics of the system may be modified without affecting the core functional principles. The system may be integrated directly into a device housing or implemented within an auxiliary system, such as a docking interface or external support structure. Variations in layout, form factor integration, and interface elements are intended to fall within the scope of the invention.

Although the embodiments illustrated in the drawings depict a laptop-form-factor computing device, the display positioning system described herein may be implemented in other portable electronic devices having a display assembly and a base structure, including tablets, portable monitors, and similar devices.

All structural features, material selections, and functional implementations described herein are illustrative rather than limiting. Any variations that achieve substantially the same function, in substantially the same way, to achieve substantially the same result are intended to fall within the scope of the present invention. Accordingly, the scope of the invention should be defined by the appended claims.

What is claimed is:

1. A portable computing device comprising:
a base housing;
a display assembly; and
a support mechanism comprising a guide structure and a plurality of articulated support members operatively coupling the display assembly to the base housing,
wherein the articulated support members are configured to transition between:
a stowed configuration, in which the articulated support members are configured to be contained within the base housing, and
a deployed configuration, in which the articulated support members extend from the base housing to support the display assembly in an elevated position relative to the base housing,
wherein the articulated support members are positioned at least partially within the base housing in the stowed configuration,
wherein the support mechanism is configured to guide movement of the display assembly relative to the base housing through a coordinated sequence of motions including:
a displacement of the display assembly relative to the base housing,
a reorientation of the articulated support members, and
an adjustment of a relative position between the display assembly and the articulated support members,
such that the display assembly follows a movement path including vertical and forward components relative to the base housing,
wherein the support mechanism is configured to provide the coordinated sequence of motions without reliance on telescopic extension elements,
wherein the coordinated sequence of motions is kinematically constrained by geometric relationships between the articulated support members and the guide structure,
wherein the displacement, reorientation, and adjustment are interdependent such that displacement of one component produces corresponding movement of other components without independent user-controlled degrees of freedom.

2. The device of claim 1, wherein the support mechanism comprises at least two articulated support members.

3. The device of claim 2, wherein the articulated support members are symmetrically positioned relative to a central axis of the base housing.

4. The device of claim 3, wherein the articulated support members are positioned inward from lateral edges of the base housing to enable forward displacement of the display assembly toward a front side of the device.

5. The device of claim 1, wherein the support mechanism is configured to translate from a stowed position within the base housing toward a deployed configuration.

6. The device of claim 1, wherein the support mechanism is configured to elevate the display assembly relative to the base housing.

7. The device of claim 1, wherein the displacement and reorientation occur in a coordinated and at least partially overlapping manner, the device being configured to maintain a substantially constant orientation angle of the display assembly during at least a portion of deployment.

8. The device of claim 1, wherein the displacement of the support mechanism along a guide path is operatively coupled to angular movement of the articulated support members through a fixed kinematic relationship defined by geometry of the articulated support members.

9. The device of claim 1, wherein the support mechanism is guided along an internal guide path integrated within the base housing.

10. The device of claim 9, wherein the internal guide path constrains motion of the support mechanism along a predefined trajectory, and wherein the predefined trajectory is defined by interaction of multiple articulated support members rather than solely by geometry of the internal guide path.

11. The device of claim 9, wherein the internal guide path comprises a profiled channel configured to reduce lateral play of the support mechanism.

12. The device of claim 1, wherein the articulated support members comprise a plurality of pivot joints.

13. The device of claim 12, wherein the pivot joints form a non-linear multi-segment kinematic arrangement forming a closed kinematic chain.

14. The device of claim 13, wherein the articulated support members form a generally Z-shaped configuration in a deployed state.

15. The device of claim 1, further comprising a data conduit routed along the support mechanism.

16. The device of claim 15, wherein the data conduit is disposed within an internal routing path defined by the support mechanism and is operatively coupled to a tensioning mechanism configured to reduce slack during movement.

17. The device of claim 16, wherein the tensioning mechanism comprises at least one of a spring-loaded element or a sliding loop guide.

18. The device of claim 1, further comprising a locking mechanism configured to secure the support mechanism in at least one deployed position and to provide a plurality of stable positions.

19. The device of claim 18, wherein the locking mechanism comprises at least one of magnetic detents or an actuation system including a mechanical transmission element or an electromechanical actuator.

20. The device of claim 1, further comprising a protective cover coupled to the support mechanism, the protective cover comprising a segmented articulated structure configured to maintain coverage continuity during movement.
